(19) United States
(12) Patent Application Publication
(10) Pub. No.: US 2025/0274193 A1
(43) Pub. Date: Aug. 28, 2025

(54) NETWORK FACILITIES MONITORING DEVICE, NETWORK FACILITIES MONITORING METHOD AND PROGRAM

(71) Applicant: Nippon Telegraph and Telephone Corporation, Tokyo (JP)

(72) Inventors: Hiroshi Shibata, Musashino-shi, Tokyo (JP); Kenichi Aoyagi, Musashino-shi, Tokyo (JP); Sachio Suda, Musashino-shi, Tokyo (JP)

(21) Appl. No.: 18/857,482

(22) PCT Filed: May 10, 2022
(86) PCT No.: PCT/JP2022/019777

§ 371 Date: Oct. 17, 2024

(51) Int. Cl. H04B 10/03

(52) U.S. Cl. CPC H04B 10/03

(57) ABSTRACT

A network facility monitoring device includes: a repetitive alarm extraction unit that extracts, from an alarm database (DB), an alarm group in which an abnormality detection alarm and a recovery detection alarm have repeatedly occurred a predetermined number of times within a predetermined time with respect to same alarm content of a same network facility as a repetitive alarm; an occurrence recovery alarm pattern DB that accumulates information of a repetitive alarm of a past case together with a cause of the repetitive alarm; and an alarm pattern collation unit that collates information of the extracted repetitive alarm with the information of the repetitive alarm of the past case and notifies a host device of the cause of the repetitive alarm of the past case in a case of determining that similarity is higher than a predetermined threshold.

### TECHNICAL FIELD

The present invention relates to a network facility monitoring technique for an optical transmission system, and more particularly to a network facility monitoring device, a network facility monitoring method, and a program.

### BACKGROUND ART

Conventionally, a technique for implementing system monitoring, alarm notification, performance visualization, and the like is known (see Non Patent Literature 1 and Non Patent Literature 2). A monitoring device described in Non Patent Literature 1 collects data from a monitoring target such as a network facility, determines a threshold, executes an action of alarm notification, and stores various data in a database.

### CITATION LIST

### Non Patent Literature

Non Patent Literature 1: “[Zukai] Zabbix towa (in Japanese) ([Illustration] What is Zabbix?)”, Assist, [online], [Searched on Apr. 16, 2022], Internet <URL: https://www.ashisuto.co.jp/product/category/system-management/zabbix/>
Non Patent Literature 2: “Zabbix 3.0 no Shinkino: Item shutoku timing no jyunanka (in Japanese) (New function of Zabbix 3.0: Flexibility of item acquisition timing)”, Qiita, Dec. 11, 2015, [online], [Searched on Apr. 16, 2022], Internet <URL: https://qiita.com/atanaka7/items/907865d6aa93e3b45ae4>

### SUMMARY OF INVENTION

### Technical Problem

However, in an optical transmission system that performs processing straight for an optical signal without change, fluctuation of a signal having an analog characteristic such as optical signal intensity occurs. Therefore, in a case of a failure mode that changes near a threshold due to this fluctuation, repetitive occurrence of abnormality detection and abnormality recovery detection is conceivable. In this state, the network facility of the optical transmission system repeatedly outputs an abnormality detection alarm for providing notification of occurrence of an abnormality and a recovery detection alarm for providing notification of recovery of the abnormality. Therefore, the monitoring device continues to notify a maintenance person of a large number of alarms per unit time. This may increase the amount of alarm confirmation work by the maintenance person, and thus increase a time required to specify a cause of the abnormality of the network facility.

Therefore, an object of the present invention is to solve the above problem and reduce the time to specify the cause of the abnormality when a large number of repetitive alarms is output from the network facility.

### Solution to Problem

A network facility monitoring device according to the present invention includes an alarm database configured to accumulate, as alarm information, an abnormality detection alarm for providing notification of occurrence of an abnormality and a recovery detection alarm for providing notification of recovery of the abnormality output from a network facility of an optical transmission system; an alarm harvesting unit configured to periodically harvest the alarm information accumulated in the alarm database and transmit the alarm information to a predetermined notification destination; a repetitive alarm extraction unit configured to extract, as a repetitive alarm, from the alarm database, an alarm group in which the abnormality detection alarm and the recovery detection alarm have repeatedly occurred a predetermined number of times within a predetermined time for same alarm content of the same network facility; an occurrence recovery alarm pattern database configured to accumulate information of the repetitive alarm of a past case together with a cause of the repetitive alarm; and an alarm pattern collation unit configured to collate information of the extracted repetitive alarm with the information of the repetitive alarm of the past case, and notify the predetermined notification destination of the cause of the repetitive alarm of the past case in a case of determining that similarity is higher than a predetermined threshold.

### Advantageous Effects of Invention

According to the present invention, it is possible to reduce a time to specify a cause of an abnormality in a case where a large number of repetitive alarms is output from a network facility.

### BRIEF DESCRIPTION OF DRAWINGS

FIG. 1 is a schematic configuration diagram of an optical transmission system including a network facility monitoring device according to the present embodiment.

FIG. 2 is a table illustrating an example of a past occurrence recovery repetitive alarm that is basic information registered in an occurrence recovery alarm pattern database of FIG. 1.

FIG. 3A is a graph illustrating a time change in a repetitive alarm.

FIG. 3B is a graph illustrating a repetitive pattern in which a cycle of the repetitive alarm is short.

FIG. 3C is a graph illustrating a repetitive pattern in which the cycle of the repetitive alarm is long.

FIG. 3D is a graph illustrating a repetitive pattern in which a variation amount of the cycle of the repetitive alarm is small.

FIG. 3E is a graph illustrating a repetitive pattern in which the variation amount of the cycle of the repetitive alarm is large.

FIG. 3F is a graph illustrating a repetitive pattern in which a ratio of abnormality duration to the cycle of the repetitive alarm is large.

FIG. 4A is a table illustrating data of an alarm group recorded in an alarm database.

FIG. 4B is a table illustrating information of the repetitive alarm extracted from the alarm database.

FIG. 5 is a table illustrating record data of candidates narrowed down from the occurrence recovery alarm pattern database.

FIG. 6 is a hardware configuration diagram illustrating an example of a computer that implements functions of the network facility monitoring device according to the present embodiment and devices.

FIG. 7 is a schematic diagram illustrating a flow of monitoring processing by the network facility monitoring device according to the present embodiment.

FIG. 8 is a flowchart illustrating a flow of processing by an alarm pattern collation unit.

FIG. 9A is a flowchart illustrating a flow of similarity determination processing of FIG. 8.

FIG. 9B is a flowchart illustrating a flow of a standby mode processing of FIG. 8.

FIG. 10 is a schematic diagram illustrating an operation in which a conventional network facility monitoring device provides notification of an abnormality detection alarm and a recovery detection alarm.

### DESCRIPTION OF EMBODIMENTS

Hereinafter, a network facility monitoring device according to the present embodiment will be described in detail with reference to the drawings.

### [Outline of System Configuration]

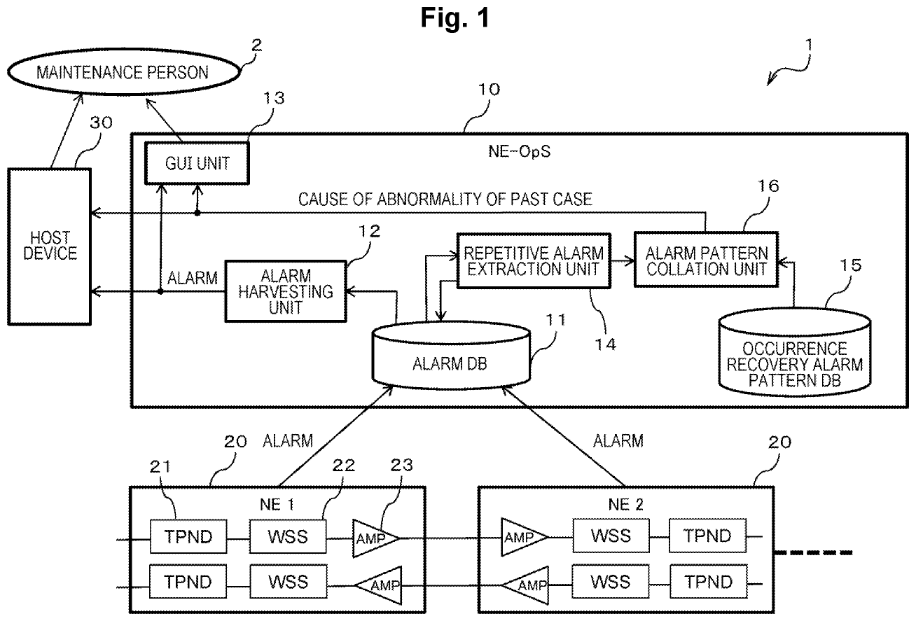

As illustrated in FIG. 1, an optical transmission system 1 includes a network facility monitoring device 10, a network facility 20, and a host device 30.

The network facility monitoring device 10 includes, for example, a network element operation system (NE-OpS), and notifies the host device 30 of an alarm acquired from the network facility 20, and notifies the host device 30 of a cause of an abnormality of a past case as necessary. The host device 30 is a device that monitors the network facility monitoring device 10, and presents an alarm or the like to a maintenance person 2.

The network facility 20 includes, for example, a transponder (TPND) 21, a wavelength selective switch (WSS) 22, and an optical amplifier (AMP) 23. The number of network facilities 20 is arbitrary. Two network facilities illustrated in FIG. 1 are denoted as NE1 and NE2 when distinguished, and are denoted as network facilities 20 when not distinguished.

For example, when an electrical signal is input from an external communication device to the transponder 21 of the network facility NE1, the electrical signal is converted into an optical signal by the transponder 21, multiplexed by the wavelength selective switch 22, amplified by the optical amplifier 23, and then transmitted to the outside. This optical signal is, for example, amplified by the optical amplifier 23 of the network facility NE2, then demultiplexed by the wavelength selective switch 22, received by the transponder 21, and transmitted to a communication device (not illustrated). Note that the optical transmission system 1 is bidirectional communication.

### [Network Facility Monitoring Device 10]

The network facility monitoring device 10 includes an alarm database 11, an alarm harvesting unit 12, a graphical user interface (GUI) unit 13, a repetitive alarm extraction unit 14, an occurrence recovery alarm pattern database 15, and an alarm pattern collation unit 16. These units may be housed in the same housing called network facility monitoring device, or may be housed in different housings. In the following description and drawings, a database is referred to as a DB.

The alarm DB 11 accumulates, as alarm information, an abnormality detection alarm for providing notification of occurrence of an abnormality and a recovery detection alarm for providing notification of recovery of the abnormality output from the network facility 20 of the optical transmission system 1. The alarm DB 11 accumulates raw alarm data. The alarm harvesting unit 12 periodically harvests the alarm information accumulated in the alarm DB 11 and transmits the information to a predetermined notification destination such as the host device 30. The GUI unit 13 presents predetermined information such as an alarm to the user. The GUI unit 13 receives a user's instruction from an input device such as a mouse, for example, and outputs information corresponding to the user's instruction to an output device such as a display. Note that since the alarm DB 11, the alarm harvesting unit 12, and the GUI unit 13 have conventionally known configurations, further description will be omitted.

The repetitive alarm extraction unit 14 extracts, from the alarm DB 11, an alarm group in which the abnormality detection alarm and the recovery detection alarm have repeatedly occurred a predetermined number of times within a predetermined time for the same alarm content of the same network facility as a repetitive alarm. The occurrence recovery alarm pattern DB 15 accumulates the information of the repetitive alarm of the past case together with the cause of the repetitive alarm. The alarm pattern collation unit 16 collates information of the repetitive alarm extracted by the repetitive alarm extraction unit 14 with information of the repetitive alarm of the past case, and notifies a predetermined notification destination of the cause of the repetitive alarm of the past case in a case of determining that similarity is higher than a predetermined threshold. Note that the cause of the alarm is not content notification of which is provided by the alarm but a true reason for the occurrence of the alarm, and indicates the cause of the abnormality of the network facility. Hereinafter, the occurrence recovery alarm pattern DB 15, the repetitive alarm extraction unit 14, and the alarm pattern collation unit 16 will be described in detail.

### [Details of Occurrence Recovery Alarm Pattern DB 15]

The information of the repetitive alarm of the past case includes basic information, the cause of the abnormality of the repetitive alarm of the past case, and statistical information. The basic information includes alarm content information, identification information of the network facility where the alarm has occurred, and information for specifying a location where the alarm has occurred. These pieces of information are recorded in association with time information of the abnormality detection alarm or the recovery detection alarm.

### (Basic Information)

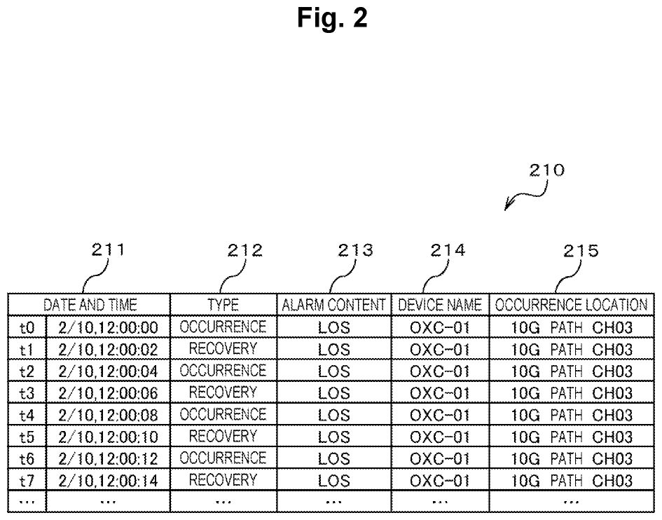

FIG. 2 is a table illustrating an example of past occurrence recovery repetitive alarms that are the basic information registered in the occurrence recovery alarm pattern DB 15. Basic information 210 illustrated in FIG. 2 includes information of items 211 to 215. The item 211 indicates date and time when the alarm has occurred. The date and time is represented by, for example, year, month, day, hour, minute, and second. The item 212 indicates a type of the alarm. In this example, “occurrence” represents the abnormality detection alarm, and “recovery” represents the recovery detection alarm. Note that, in the item 211, the time t0 indicates the date and time when the first abnormality detection alarm in the repetitive alarm has occurred. Further, the time t1 indicates the date and time when the first recovery detection alarm in the repetitive alarm has occurred. The item 213 indicates alarm content. LOS represents loss of signal. The item 214 indicates a name of a device that has output the alarm. OXC represents optical cross-connect. The item 215 indicates a location where the alarm has occurred. 10G path CH03 represents 10 giga bits per second path channel 03. Note that a value of each item of the basic information 210 is an example.

### (Cause of Abnormality)

The cause of the abnormality in the repetitive alarm of the past case is, for example, a failure of the wavelength selective switch (WSS) 22, a failure of the optical amplifier (AMP) 23, or the like. There are various repetitive patterns of the alarm for providing notification of the abnormality and the alarm for providing notification of the restoration depending on the failure location of the device, and it is difficult to specify the cause of the abnormality. Even if the alarm content indicates “LOS”, it is difficult to specify whether the cause of the abnormality is the failure of the wavelength selective switch (WSS) or the failure of the optical amplifier (AMP).

For example, in a case where there is fluctuation in an output of the wavelength selective switch (WSS), alarms of LOS, recovery, LOS, recovery, . . . are repeated in a predetermined network facility 20.

Further, in a case where there is fluctuation in an output of the optical amplifier (AMP), an event in which alarms of LOS, recovery, LOS, recovery, . . . are repeated occurs in the predetermined network facility 20, and alarms of LOS, recovery, LOS, recovery, . . . are also repeated in another network facility 20. That is, the repetitive alarm may spread to other devices. The spread is an event in which repetitive alarms related to abnormalities from a plurality of locations occur for one cause, for example, the failure of the optical amplifier.

### (Statistical Information)

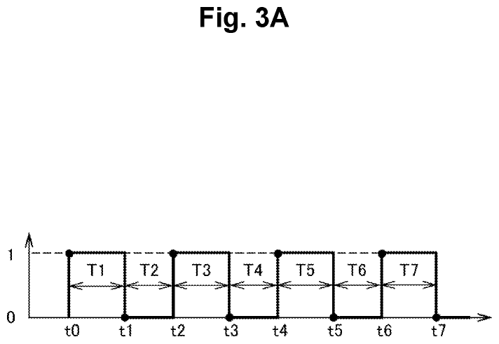

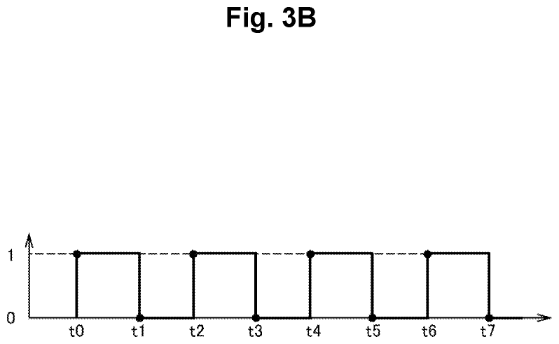

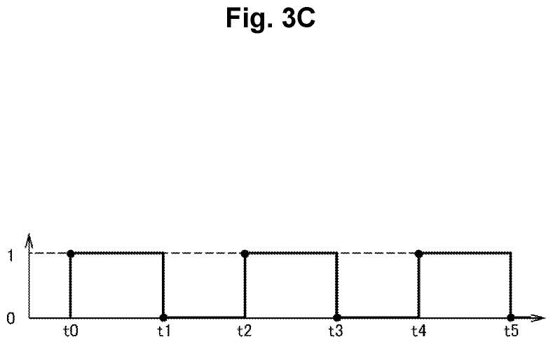

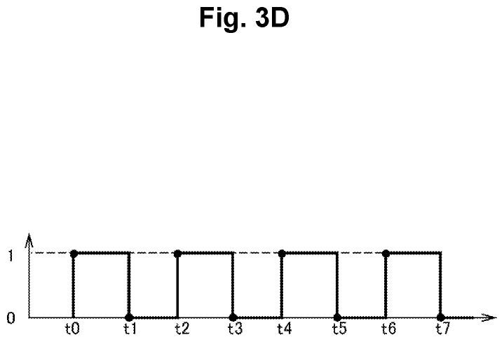

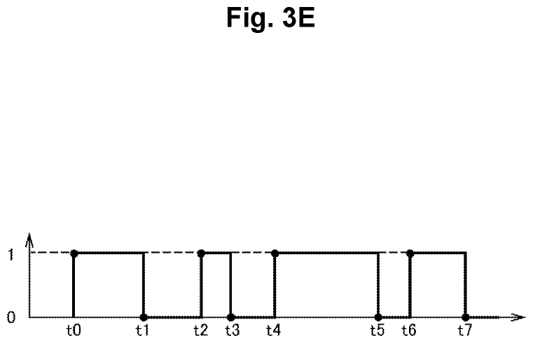

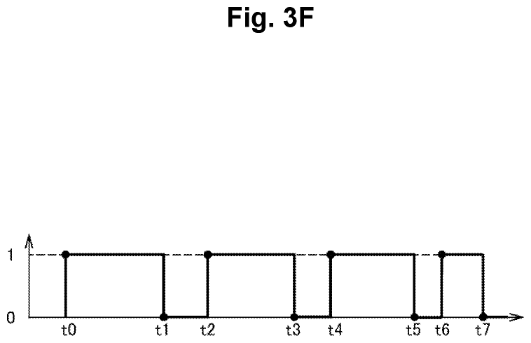

The statistical information registered in the occurrence recovery alarm pattern DB 15 is information calculated using the time information as feature information of a repetitive pattern for the repetitive alarm of the past case. Here, the repetitive pattern will be described with reference to FIG. 3A. FIG. 3A is a graph illustrating a time change in the repetitive alarm. The horizontal axis is a time axis and represents the time information of the repetitive alarm. The vertical axis represents the type of the alarm by binarization. The abnormality detection alarm is represented by 1, and the recovery detection alarm is represented by 0. FIGS. 3B to 3F are graphs illustrating other repetitive patterns. Details of these repetitive patterns will be described below.

Hereinafter, a period from occurrence time of the abnormality detection alarm to occurrence time of the recovery detection alarm is referred to as abnormality duration. A period from the occurrence time of the recovery detection alarm to the occurrence time of the next abnormality detection alarm is referred to as recovery duration. A period obtained by combining the abnormality duration and the recovery duration following the abnormality duration is referred to as a cycle.

Specifically, in FIG. 3A, a period T1 from the time t0 to the time t1 is first abnormality duration. A period T2 from the time t1 to the time t2 is first recovery duration. A period T3 from the time t2 to the time t3 is second abnormality duration. A period T4 from the time t3 to the time t4 is second recovery duration. A period T5 from the time t4 to the time t5 is third abnormality duration. A period T6 from the time t5 to the time t6 is third recovery duration. A period T7 from the time t6 to the time t7 is fourth abnormality duration.

Further, a sum of the period T1 and the period T2 is a first cycle. The sum of the period T3 and the period T4 is a second cycle. The sum of the period T4 and the period T5 is a third cycle. Note that the cycle is not necessarily constant.

### (Feature Information)

The feature information of the repetitive pattern is, for example, an average value of alarm occurrence intervals, a standard deviation of alarm occurrence intervals, a ratio of an abnormality duration time in the repetitive alarm, and the like.

The average value of alarm occurrence intervals is an average value of intervals between output time of the abnormality detection alarm and output time of the recovery detection alarm. In the case of the repetitive pattern up to the time t7 illustrated in FIG. 3A, the average value of alarm occurrence intervals is the average value of the abnormality duration T1, T3, T5, and T7 and the recovery duration T2, T4, and T6. In a case of using the time information from the time t0 to the time tn, the average value of alarm occurrence intervals is calculated by the following Expression (1).

$$\begin{matrix}[ Math . 1 ] & \\ \frac{1}{n} {\sum }_{k = 1}^{n} Tk & Expression ( 1 )\end{matrix}$$

The standard deviation of alarm occurrence intervals indicates a variation in the alarm generation intervals. When the average value of alarm occurrence intervals given in Expression (1) is used, a standard deviation σ of the alarm occurrence intervals is expressed by the following Expression (2).

$$\begin{matrix}[ Math . 2 ] & \\ \begin{matrix}σ = \sqrt{\frac{1}{n} {\sum }_{k = 1}^{n} {( Tk - \hat{T} )}^{2} ,} \\ where \hat{T} = \frac{1}{n} {\sum }_{k = 1}^{n} T k .\end{matrix} & Expression ( 2 )\end{matrix}$$

The ratio of an abnormality duration time in the repetitive alarm is the abnormality duration with respect to the cycle of the repetitive alarm. More specifically, a ratio r of the abnormality duration time in the repetitive alarm is calculated by the following Expression (3).

$$\begin{matrix}[ Math . 3 ] & \\ r = \frac{E 1}{E 1 + E 2} & Expression ( 3 )\end{matrix}$$

In Expression (3), E1 is an average value of the abnormality duration. E2 is an average value of the recovery duration. In the case of the repetitive pattern up to the time t7 illustrated in FIG. 3A, E1=(T1+T3+T5+T7)/4, and E2=(T2+T4+T6)/3.

### (Range of Similarity Coefficients)

The information registered in the occurrence recovery alarm pattern DB 15 can further include a range of similarity coefficients set in advance corresponding to an allowable range from a reference value (statistical information) of the similarity. The range of similarity coefficients is a range including a case where the statistical information of the repetitive alarm to be compared and the statistical information of the past case are the same (100%) as a reference. The range of similarity coefficients is determined by a lower limit value and an upper limit value. A calculation result obtained by multiplying the value of the statistical information of the past case and the lower limit value of the similarity coefficient is a threshold (lower limit value) for determining that the similarity is high. A calculation result obtained by multiplying the value of the statistical information of the past case and the upper limit value of the similarity coefficient is a threshold (upper limit value) for determining that the similarity is high. Note that the alarm pattern collation unit 16 calculates the statistical information as the feature information of the repetitive pattern, using the extracted time information of the repetitive alarm, and collates the statistical information with the statistical information of the repetitive alarm of the past case to determine the similarity.

### (Spread Event)

The information registered in the occurrence recovery alarm pattern DB 15 can further include a spread event. That is, the information of the repetitive alarm of the past case can further include information indicating whether the repetitive alarm has spread from the network facility 20 in which the repetitive alarm of the past case has occurred to another network facility 20. In a case where there is a repetitive alarm spread, identification information of the another network facility 20 to which the repetitive alarm has spread and the feature information of the repetitive pattern of the repetitive alarm that has occurred as a spread event are included.

### [Details of Repetitive Alarm Extraction Unit 14]

The repetitive alarm extraction unit 14 periodically searches the alarm DB 11 for the repetitive alarm. Here, as extraction conditions of the repetitive alarm, a repetition time and the number of repetitions of the alarm are defined in advance. The repetition time of the alarm is favorably short, and may be, for example, 60 seconds. The same alarm content output from the same network facility may be, for example, “LOS in 10G path CH03”. The number of times of any alarm may be, for example, 5 times, 7 times, or 10 times. In a case of finding alarm groups that satisfy the extraction conditions by the search, the repetitive alarm extraction unit 14 extracts the alarm group recorded a predetermined number of times (for example, 5 times) or more as one repetitive alarm and passes the same to the alarm pattern collation unit 16.

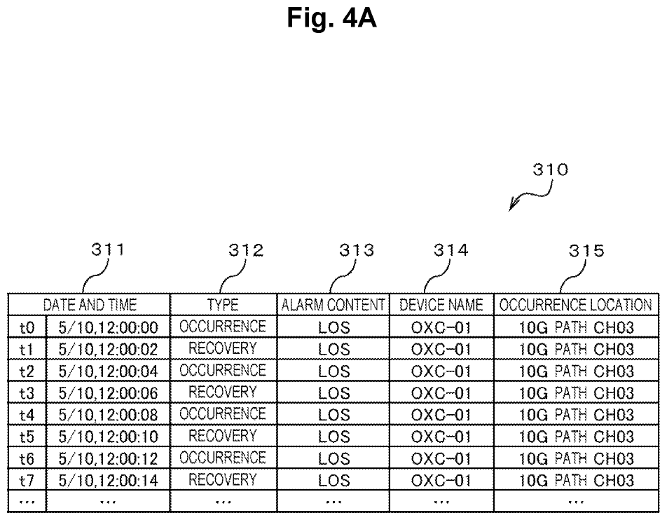

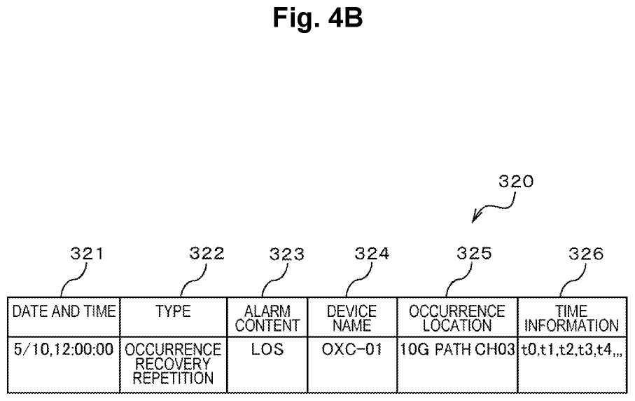

FIG. 4A is a table illustrating data of an alarm group recorded in the alarm DB 11. Data 310 of the alarm group illustrated in FIG. 4A includes information regarding items 311 to 315. The items 311 to 315 are similar to the items 211 to 215 of the basic information 210 regarding the repetitive alarm of the past case registered in advance. Note that a value of each item of the alarm group data 310 is an example.

Here, it is assumed that the data 310 of the alarm group indicates that the abnormality detection alarm and the recovery detection alarm have repeatedly occurred a predetermined number of times (for example, 10 times) within a predetermined time (for example, 60 seconds) for the same alarm content (LOS) of the same device (OXC-01). The repetitive alarm extraction unit 14 combines the data 310 of the alarm group into information 320 of one repetitive alarm as illustrated in FIG. 4B, and passes the information 320 of the repetitive alarm to the alarm pattern collation unit 16.

As illustrated in FIG. 4B, the repetitive alarm information 320 includes information regarding items 321 to 326. The item 321 indicates date and time when the repetitive alarm has occurred. This date and time is represented by, for example, the date and time when the first abnormality detection alarm of the repetitive alarm has occurred. The item 322 indicates the type of the alarm. In this example, “occurrence recovery repetition” represents repetition of the abnormality detection alarm and the recovery detection alarm. The item 323 indicates the alarm content. The item 324 indicates the name of the device that has output the alarm. The item 325 indicates the location where the alarm has occurred. The item 326 indicates the time information of each alarm in the repetitive alarm. This time information is information of the date and time when each of a predetermined number of times (for example, five) alarms has occurred. Note that the value of each item of the information 320 of the repetitive alarm is an example.

In a case of finding the alarm group that satisfies the extraction conditions by the search, the repetitive alarm extraction unit 14 may record the information of the extracted repetitive alarm in an identifiable manner. In this case, in a case where the repetitive alarm regarding the same alarm content output from the same network facility is extracted every time by the periodic search, the repetitive alarm extraction unit 14 determines that the abnormality of the network facility continues. On the other hand, in a case where the repetitive alarm extraction unit 14 becomes no longer able to extract the repetitive alarm, which had been extracted every time, by the search performed within a predetermined period, it is possible to determine that the network facility has been restored. As will be described below, in a case of determining that the network facility that had output the repetitive alarm has been restored after the repetitive alarm harvesting becomes in a stopped state, the repetitive alarm extraction unit 14 can instruct the alarm harvesting unit 12 to cancel the stopped state of the repetitive alarm harvesting.

### [Details of Alarm Pattern Collation Unit 16]

When acquiring the information 320 of the repetitive alarm illustrated in FIG. 4B from the repetitive alarm extraction unit 14, the alarm pattern collation unit 16 starts similarity determination processing. The alarm pattern collation unit 16 narrows down candidates to be collated with the information 320 of the repetitive alarm from the past cases accumulated in advance in the occurrence recovery alarm pattern DB 15. The alarm pattern collation unit 16 extracts the past case in which the alarm content is described as record data of the candidates to be collated on the basis of the information of the alarm content 323 described in the information 320 of the repetitive alarm.

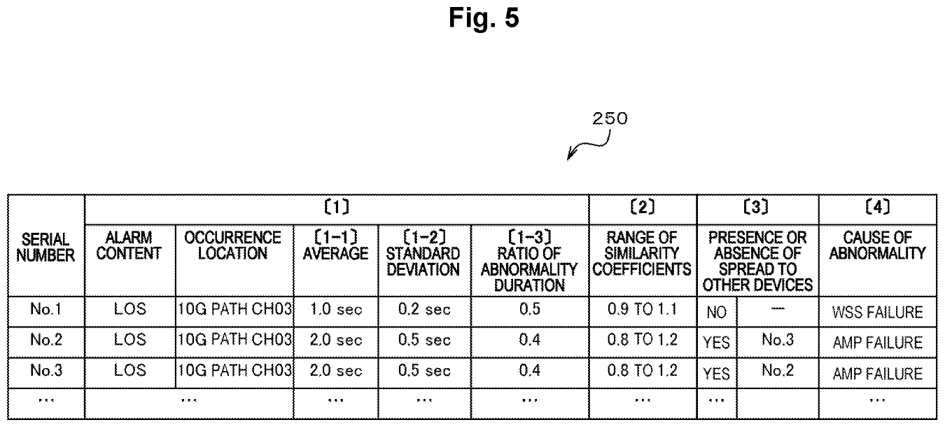

FIG. 5 is a table illustrating the record data of the candidates narrowed down from the occurrence recovery alarm pattern DB 15. Table 250 illustrated in FIG. 5 includes items of serial number, [1], [2], [3], and [4]. Specific data is recorded in each of candidates of entry No. 1, entry No. 2, and entry No. 3.

The item [1] includes the basic information and the statistical information of the repetitive alarm of the past case. The basic information of the repetitive alarm includes the information of the alarm content and the information of the occurrence location.

The statistical information of the item [1] includes items [1-1], [1-2], and [1-3]. The item [1-1] indicates the average value of alarm occurrence intervals. The average value of alarm occurrence intervals is calculated by the above-described Expression (1). The item [1-2] indicates the standard deviation of alarm occurrence intervals. The standard deviation of alarm occurrence intervals is calculated by the above-described Expression (2). The item [1-3] indicates the ratio of an abnormality duration time in the repetitive alarm. The ratio of an abnormality duration time in the repetitive alarm is calculated by the above-described Expression (3).

The item [2] indicates the range of similarity coefficients used for similarity determination. The range of similarity coefficients for the candidate of entry No. 1 is “0.9 to 1.1”. The range of similarity coefficients for each of the candidates of entry No. 2 and No. 3 is “0.8 to 1.2”.

The item [3] indicates whether the repetitive alarm has spread to other devices as a spread event. As for the candidate of entry No. 1, no repetitive alarm has spread to other devices. As for the candidate of entry No. 2, the repetitive alarm has actually spread to the device of entry No. 3. As for the candidate of entry No. 3, the repetitive alarm has actually spread to the device of entry No. 2.

The item [4] indicates the cause of the abnormality in the repetitive alarm of the past case. The cause of the abnormality in the candidate of entry No. 1 is a failure of the wavelength selective switch (WSS). The cause of the abnormality in the candidates of entry Nos. 2 and 3 is a failure of the optical amplifier (AMP).

Next, a relationship between the statistical information used by the alarm pattern collation unit 16 to determine the similarity and the repetitive pattern of the repetitive alarm will be described with reference to FIGS. 3B to 3F. The alarm pattern collation unit 16 performs the repetitive alarm pattern collation using the following three viewpoint criteria as an example of the repetitive pattern.

### [First Viewpoint]

The repetitive alarm having the repetitive pattern illustrated in FIG. 3B is not similar to the repetitive alarm having the repetitive pattern illustrated in FIG. 3C. The period (first cycle) from the time t0 to the time t2 illustrated in FIG. 3B is shorter than the period (first cycle) from the time t0 to the time t2 illustrated in FIG. 3C. That is, it can be seen that the repetitive alarm having the repetitive pattern illustrated in FIG. 3B has a shorter cycle than the repetitive alarm having the repetitive pattern illustrated in FIG. 3C, and the similarity between them is low. Therefore, from the first viewpoint, the alarm pattern collation unit 16 determines the similarity with reference to the item [1-1] the average value of alarm occurrence intervals illustrated in FIG. 5.

### [Second Viewpoint]

The repetitive alarm having the repetitive pattern illustrated in FIG. 3D is not similar to the repetitive alarm having the repetitive pattern illustrated in FIG. 3E. The period (first cycle) from the time t0 to the time t2 illustrated in FIG. 3D is not much different from the period (second cycle) from the time t2 to the time t4. The period (first cycle) from the time t0 to the time t2 illustrated in FIG. 3E is longer than the period (second cycle) from the time t2 to the time t4. That is, it can be seen that the repetitive alarm having the repetitive pattern illustrated in FIG. 3E has a larger variation amount in cycle than the repetitive alarm having the repetitive pattern illustrated in FIG. 3D, and the similarity between them is low. Therefore, from the second viewpoint, the alarm pattern collation unit 16 determines the similarity with reference to the item [1-2] the standard deviation of alarm occurrence intervals (variation in time intervals) illustrated in FIG. 5.

### [Third Viewpoint]

The repetitive alarm having the repetitive pattern illustrated in FIG. 3F has a feature that the abnormality duration is longer than the recovery duration. Focusing on the period (first cycle) from the time t0 to the time t2 illustrated in FIG. 3F, the abnormality duration from the time t0 to the time t1 is about twice the recovery duration from the time t1 to the time t2. In addition, this repetitive alarm has a similar tendency in the second cycle and the third cycle. That is, it can be seen that the repetitive alarm having the repetitive pattern illustrated in FIG. 3F has a large ratio of the abnormality duration to the cycle. Therefore, from the third viewpoint, the alarm pattern collation unit 16 determines the similarity on the basis of the item [1-3] the ratio of the abnormality duration time in the repetitive alarm illustrated in FIG. 5.

In the similarity determination processing, the alarm pattern collation unit 16 can determine the similarity without applying a processing load of the CPU and quickly detect whether the pattern matches a representative failure case, with a smaller amount of calculation than that in the related art. Note that AI technology such as machine learning can also be used to determine the similarity.

The alarm pattern collation unit 16 has a function to execute notification processing to the host device 30 and the like in addition to the similarity determination processing. These functions will be described below together with the processing operation of the alarm pattern collation unit 16.

### [Hardware Configuration]

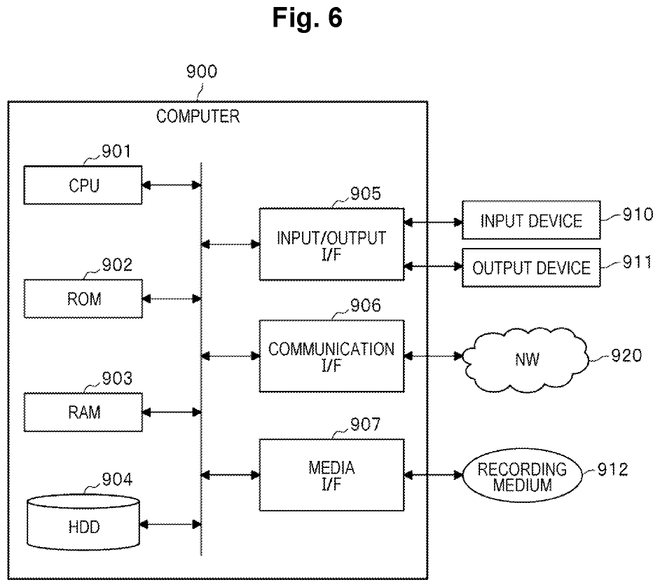

The network facility monitoring device 10 according to the above embodiment is implemented by, for example, a computer 900 having a configuration as illustrated in FIG. 6.

FIG. 6 is a hardware configuration diagram illustrating an example of the computer 900 that implements the functions of the network facility monitoring device 10 according to the present embodiment. The computer 900 includes a central processing unit (CPU) 901, a read only memory (ROM) 902, a random access memory (RAM) 903, a hard disk drive (HDD) 904, an input/output interface (I/F) 905, a communication I/F 906, and a media I/F 907.

The CPU 901 operates on the basis of a program stored in the ROM 902 or the HDD 904. The ROM 902 stores a boot program to be executed by the CPU 901 when the computer 900 is started, a program related to hardware of the computer 900, and the like.

The CPU 901 controls an input device 910 such as a mouse or a keyboard and an output device 911 such as a display or a printer via the input/output I/F 905. The CPU 901 acquires data from the input device 910 and outputs generated data to the output device 911 via the input/output I/F 905. Note that a graphics processing unit (GPU) or the like may be used as a processor together with the CPU 901.

The HDD 904 stores a program to be executed by the CPU 901, data to be used by the program, and the like. The communication I/F 906 receives data from another device via a communication network 920 and outputs the data to the CPU 901, and transmits data generated by the CPU 901 to another device via the communication network 920.

The media I/F 907 reads a program or data stored in a recording medium 912, and outputs the program or data to the CPU 901 via the RAM 903. The CPU 901 loads a program related to objective processing from the recording medium 912 into the RAM 903 via the media I/F 907 and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a semiconductor memory, or the like.

For example, when the computer 900 functions as the network facility monitoring device 10 according to the above embodiment, the CPU 901 implements the functions of the network facility monitoring device 10 by executing the program loaded on the RAM 903. Further, the HDD 904 stores data in the RAM 903. The CPU 901 reads the program related to the objective processing from the recording medium 912 and executes the program. In addition, the CPU 901 may read the program regarding the objective processing from another device via the communication network 920.

### [Operation of Network Facility Monitoring Device]

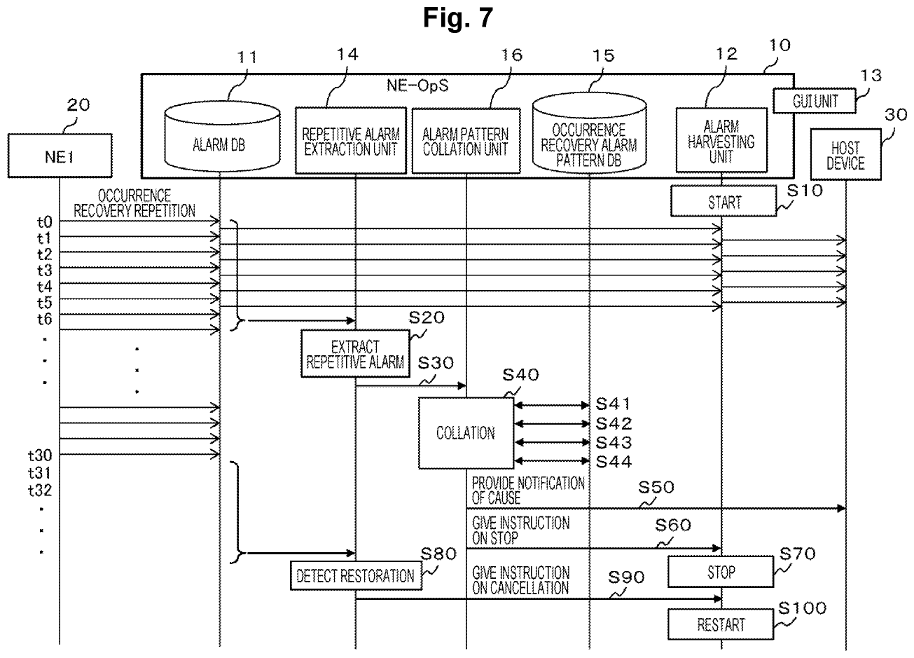

Next, a flow of monitoring processing by the network facility monitoring device 10 will be described with reference to FIG. 7 (see FIG. 1 as appropriate).

In the network facility monitoring device 10, the alarm harvesting unit 12 starts and executes harvesting processing and transmission processing (step S10). Here, for example, it is assumed that the abnormality detection alarm and the recovery detection alarm are repeated for the same alarm content of the network facility NE1, and each alarm is accumulated in the alarm DB 11. When the alarm harvesting unit 12 performs the harvesting processing for alarms, the corresponding alarm is deleted from the alarm DB 11. When the periodic harvesting processing is not performed, the repetitive alarm extraction unit 14 determines that, for example, the alarm group from the time to to the time t6 satisfies the conditions. In this case, the repetitive alarm extraction unit 14 extracts the repetitive alarm in which the alarm group from the time t0 to the time t6 is collected (step S20). Then, the repetitive alarm extraction unit 14 passes the extracted repetitive alarm to the alarm pattern collation unit 16 (step S30).

The alarm pattern collation unit 16 executes similar pattern detection processing by collation between the received repetitive alarm and the repetitive alarm of the past case recorded in the occurrence recovery alarm pattern DB 15 (step S40). Details of this processing will be described below. Then, in a case of determining that the similarity is high, the alarm pattern collation unit 16 notifies the host device 30 of the cause of the repetitive alarm of the past case (step S50). Further, the alarm pattern collation unit 16 instructs the alarm harvesting unit 12 to stop the harvesting processing (step S60). The content of the harvesting stop instruction is, for example, stopping harvesting for the abnormality detection alarm and the recovery detection alarm having entries of the “device name: OXC-01”, the “occurrence location: 10G path CH03”, and the alarm content “LOS”. As a result, the alarm harvesting unit 12 stops the harvesting processing and transmission processing for alarms (step S70). Note that, in a case of determining that the similarity between the received repetitive alarm and the repetitive alarm of the past case is low, the alarm pattern collation unit 16 does not execute step S50 and step S60.

Even after the harvesting stopped state, the output of the abnormality detection alarm and the recovery detection alarm from the network facility NE1 continues for a while, but the alarms stop for a predetermined period at or after the time t31, for example. At this time, the alarms from the network facility NE1 are not accumulated in the alarm DB 11 over a predetermined period. As a result, the repetitive alarm extraction unit 14 detects the restoration of the network facility NE1 (step S80). Then, the repetitive alarm extraction unit 14 instructs the alarm harvesting unit 12 to cancel the harvesting stopped state (step S90). The content of the harvesting stop cancellation instruction is, for example, cancelling harvesting stop for the abnormality detection alarm and the recovery detection alarm having entries of the “device name: OXC-01”, the “occurrence location: 10G path CH03”, and the alarm content “LOS”. As a result, the alarm harvesting unit 12 restarts and executes the harvesting processing and transmission processing for alarms (step S100).

Note that the alarm pattern collation unit 16 may notify the repetitive alarm extraction unit 14 that the alarm pattern collation unit 16 has instructed the alarm harvesting unit 12 to stop the harvesting processing. As a result, it is possible to reliably prevent such a malfunction that the repetitive alarm extraction unit 14 gives an instruction on cancellation when the alarm harvesting unit 12 is not in the harvesting stopped state.

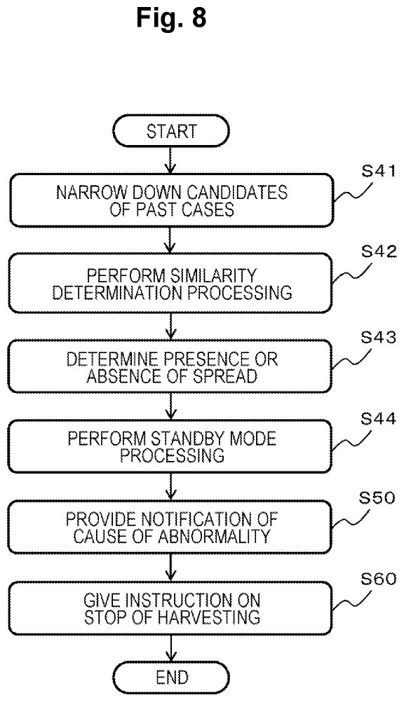

Next, a flow of processing by the alarm pattern collation unit 16 will be described with reference to FIG. 8 (see FIG. 7 as appropriate). Note that the alarm pattern collation unit 16 does not necessarily execute all pieces of processing described in FIG. 8 every time.

First, when acquiring the information 320 of the repetitive alarm (FIG. 4B) from the repetitive alarm extraction unit 14, the alarm pattern collation unit 16 narrows down the candidates of past cases (step S41). At this time, the alarm pattern collation unit 16 creates the table 250 (FIG. 5) that stores the record data of each candidate of the past case to be collated with the information 320 of the repetitive alarm. Then, the alarm pattern collation unit 16 executes similarity determination processing (step S42) with each candidate to be collated with the information 320 of the repetitive alarm.

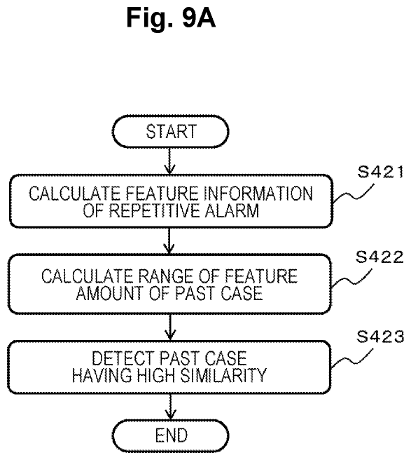

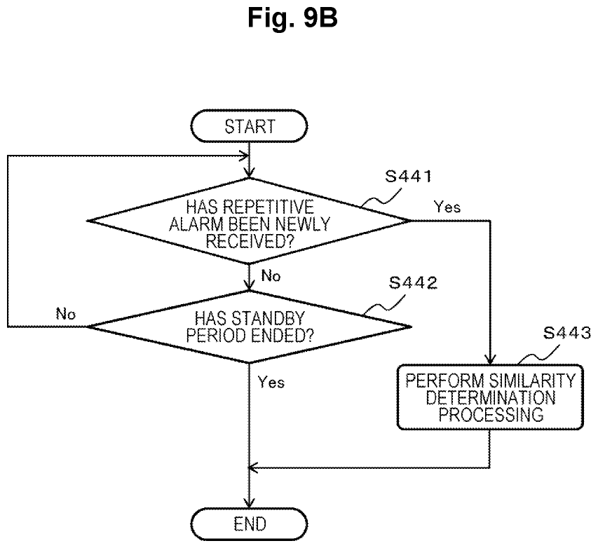

In this similarity determination processing (step S42), as illustrated in FIG. 9A, the alarm pattern collation unit 16 calculates the feature information of the repetitive alarm from the time information 326 of the information 320 of the repetitive alarm (FIG. 4B) (step S421). Here, the alarm pattern collation unit 16 calculates each piece of statistical information using the above-described expressions (1) to (3) as the feature information of the repetitive alarm in question.

In addition, the alarm pattern collation unit 16 calculates the range of the feature information of the past case for each candidate of the past case (step S422). Here, the alarm pattern collation unit 16 calculates the range of the feature information of the past case using the statistical information of the item [1] and the range of similarity coefficients of the item [2] in the table 250 (FIG. 5). Specifically, in the case of entry No. 1 illustrated in FIG. 5, the range of the similarity coefficient is set to “0.9 to 1.1”, and the average value of alarm occurrence intervals is “1.0 sec”. In this case, the range (threshold range) of the feature information of the past case is “0.9 to 1.1 sec”. At this time, if the average value of the occurrence intervals calculated from the repetitive alarm in question falls within the range of “0.9 to 1.1 sec”, it is determined that the similarity with the past case is high.

Next, the alarm pattern collation unit 16 detects the past case having high similarity with the repetitive alarm in question (step S423). Here, the alarm pattern collation unit 16 sequentially performs the similarity determination processing for each candidate (No. 1, No. 2, or No. 3 illustrated in FIG. 5) to be collated with the information 320 of the repetitive alarm illustrated in FIG. 4B. Then, in a case where the alarm pattern collation unit 16 can determine that the similarity is high from all of the first to third viewpoints, the alarm pattern collation unit 16 determines that the repetitive alarm extracted from the alarm DB 11 has high similarity with the past case. In a case where there is no candidate that can be determined to have high similarity from all the viewpoints, the alarm pattern collation unit 16 terminates the processing.

On the other hand, in the case where there is a candidate that can be determined to have high similarity from all the viewpoints, the alarm pattern collation unit 16 determines the presence or absence of spread (step S43: FIG. 8). That is, the alarm pattern collation unit 16 determines whether the spread event is registered in the past case having high similarity.

For example, in a case where the past case having high similarity is entry No. 1 illustrated in FIG. 5, the spread event is not registered. Therefore, the alarm pattern collation unit 16 notifies the host device 30 of the cause “WSS failure” of the repetitive alarm of the past case of entry No. 1 (step S50).

In addition, for example, in a case where the past case having high similarity is entry No. 2 illustrated in FIG. 5, entry No. 3 is registered as the spread case. Therefore, the alarm pattern collation unit 16 executes standby mode processing (step S44: FIG. 8). In the standby mode processing (step S44), a predetermined standby period (for example, 120 seconds) is set. During this standby period, as illustrated in FIG. 9B, the alarm pattern collation unit 16 determines whether the repetitive alarm has been newly received from the repetitive alarm extraction unit 14 (step S441). In a case where the repetitive alarm has not been newly received (step S441: No), the alarm pattern collation unit 16 determines whether the standby period has ended (step S442). In a case where the standby period has ended (step S442: Yes), the alarm pattern collation unit 16 terminates the processing.

On the other hand, in a case where the standby period has not ended in step S442 (step S442: No), the alarm pattern collation unit 16 returns to step S441. Then, in a case where the repetitive alarm has been newly received in the standby period (step S441: Yes), the alarm pattern collation unit 16 executes the similarity determination processing (step S443) and terminates the standby mode processing. The similarity determination processing in step S443 is similar to the similarity determination processing in step S42 (FIG. 9A). In step S443, the alarm pattern collation unit 16 similarly determines similarity by using all the first to third viewpoints described above. Note that the candidate of the past case is the information of the repetitive alarm (for example, the information of entry No. 3) accumulated as the spread event of the past case. Further, the repetitive alarm in question is the new repetitive alarm that has occurred during the standby period.

In a case of determining that the similarity between the new repetitive alarm and the repetitive alarm of the past spread case is low in step S443, the alarm pattern collation unit 16 terminates the processing.

On the other hand, in a case of determining that the similarity between the new repetitive alarm and the repetitive alarm of the past spread case is high in step S443, the alarm pattern collation unit 16 notifies the host device 30 of the cause “AMP failure” of the abnormality of the past case of entry No. 2 in step S50.

In addition, after notifying the host device 30 of the cause of the abnormality of the past case, the alarm pattern collation unit 16 instructs the alarm harvesting unit 12 to stop each of the harvesting processing and the transmission processing for the repetitive alarm determined to have high similarity to the past case (step S60). The alarm harvesting unit 12 does not need to notify the host device 30 of the repetitive alarm after providing notification of the cause of the repetitive alarm. The system load can be reduced by the alarm harvesting unit 12 stopping the processing of repeatedly notifying the host device 30 of the repetitive alarm.

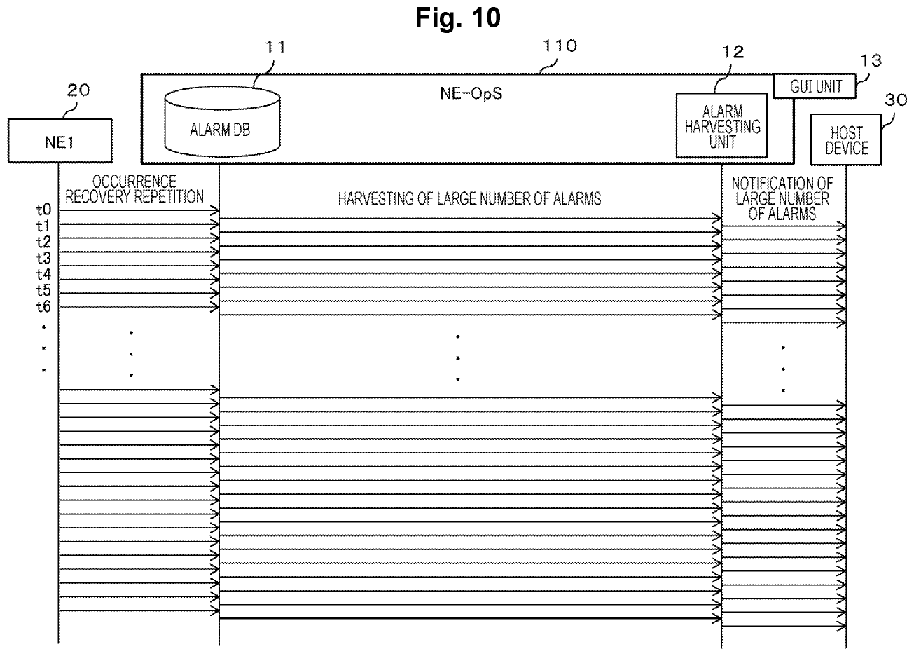

Next, advantageous points of the operation of the network facility monitoring device according to the present embodiment will be described with reference to FIGS. 10 and 7. FIG. 10 is a schematic diagram illustrating an operation in which a conventional network facility monitoring device provides notification of the abnormality detection alarm and the recovery detection alarm. As illustrated in FIG. 10, a conventional network facility monitoring device 110 accumulates alarm data notification of which is provided from the network facility 20 in the alarm DB 11. In the network facility monitoring device 110, the alarm harvesting unit 12 periodically harvests alarms from the alarm DB 11 and transmits the alarms to the host device 30.

As illustrated in FIG. 10, in the conventional network facility monitoring device 110, for example, when the abnormality detection alarm and the recovery detection alarm repeatedly occur for the same alarm content of the network facility NE1, notification of a large number of alarms is provided from the network facility monitoring device 110 to the host device 30. As a result, since the host device 30 displays the large number of alarms, confirmation work by the maintenance person is increased. Therefore, it takes time for the maintenance person to specify the cause of the abnormality of the network facility NE1.

In addition, when the abnormality detection alarm and the recovery detection alarm repeatedly occur, the load of processing of harvesting the large number of alarms from the alarm DB 11 increases in the alarm harvesting unit 12. As a result, there has been a possibility of occurrence of problems that delay of an alarm from the alarm harvesting unit 12 to the host device 30 and leakage of an alarm notification of which is to be provided from the alarm harvesting unit 12 to the host device 30.

In contrast, in the network facility monitoring device 10 illustrated in FIG. 7, the repetitive pattern of the repetitive alarm according to the past case and the cause of the abnormality are registered in the occurrence recovery alarm pattern DB 15. In addition, when the abnormality detection alarm and the recovery detection alarm repeatedly occur, the repetitive alarm extraction unit 14 extracts the repetitive alarm and passes the same to the alarm pattern collation unit 16. Then, the alarm pattern collation unit 16 determines the similarity with the repetitive pattern in the past failure case, and notifies the maintenance person of the cause of the abnormality in the past case determined to have high similarity. Furthermore, after detecting the past case having high similarity, the network facility monitoring device 10 stops the harvesting processing for the repetitive alarms and stops notifying the host device 30 of alarms, thereby reducing the system load. Therefore, according to the network facility monitoring device 10, it is possible to facilitate the maintenance person to specify a failure part and to suppress a large amount of alarm outputs with respect to the occurrence of the failure caused in the main signal in the optical transmission system 1.

### [Effects]

As described above, the network facility monitoring device includes the alarm database 11 configured to accumulate, as the alarm information, the abnormality detection alarm for providing notification of occurrence of an abnormality and the recovery detection alarm for providing notification of recovery of the abnormality output from the network facility 20 of the optical transmission system 1, the alarm harvesting unit 12 configured to periodically harvest the alarm information accumulated in the alarm database 11 and transmit the alarm information to a predetermined notification destination (host device 30), the repetitive alarm extraction unit 14 configured to extract, as the repetitive alarm, from the alarm database 11, the alarm group in which the abnormality detection alarm and the recovery detection alarm have repeatedly occurred a predetermined number of times within a predetermined time for the same alarm content of the same network facility, the occurrence recovery alarm pattern database 15 configured to accumulate information of the repetitive alarm of the past case together with the cause of the repetitive alarm, and the alarm pattern collation unit 16 configured to collate the information of the extracted repetitive alarm with the information of the repetitive alarm of the past case, and notify the predetermined notification destination (host device 30) of the cause of the repetitive alarm of the past case in the case of determining that the similarity is higher than a predetermined threshold.

With the configuration, in the network facility monitoring device, the alarm pattern collation unit 16 can provide notification of the cause of the repetitive alarm of the past case in the case where the past cases having similarity higher than the predetermined threshold are accumulated with respect to the repetitive alarms that provide notification of the occurrence of the abnormality and the recovery of the abnormality. Therefore, the maintenance person of the network facility can quickly specify the cause of the repetitive alarm.

In the network facility monitoring device, the information of the repetitive alarm of the past case includes the basic information including the alarm content information, the identification information of the network facility 20 where an alarm has occurred, and the information for specifying the location where the alarm has occurred, each of the pieces of information being recorded in association with the time information of the abnormality detection alarm or the recovery detection alarm, and the statistical information calculated using the time information as the feature information of the repetitive pattern, and the alarm pattern collation unit 16 calculates the statistical information as the feature information of the repetitive pattern, using the time information of the extracted repetitive alarm, and determines the similarity by collating the calculated statistical information with the statistical information of the repetitive alarm of the past case.

With the configuration, in the network facility monitoring device, the occurrence recovery alarm pattern database 15 can accumulate the detailed information of the abnormality detection alarm or the recovery detection alarm itself and the statistical information calculated using the time information. In addition, since the alarm pattern collation unit 16 determines the similarity between the extracted repetitive alarm and the repetitive alarm of the past case by collating the pieces of statistical information with each other, the processing load of calculation can be reduced.

In the network facility monitoring device, the information of the repetitive alarm of the past case includes the information indicating whether the repetitive alarm of the past case has spread from the network facility 20 in which the repetitive alarm has occurred to another network facility 20, the identification information of the another network facility 20 to which the repetitive alarm has spread, and the feature information of the repetitive pattern of the repetitive alarm that has occurred as the spread event, and the alarm pattern collation unit 16 stands by for a predetermined period in the case where information indicating that the repetitive alarm of the past case in which similarity to the extracted repetitive alarm is determined to be higher than a predetermined threshold has spread is accumulated, and collates information of a new repetitive alarm with the information of the repetitive alarm accumulated as the spread event of the past case to determine the similarity in a case where the new repetitive alarm has occurred in the predetermined period.

With the configuration, in the network facility monitoring device, in the case where the information indicating that the repetitive alarm of the past case in which the similarity to the extracted repetitive alarm is determined to be higher than the predetermined threshold has spread is accumulated, the alarm pattern collation unit 16 can determine whether the extracted repetitive alarm spreads to another network facility. Therefore, in a case where the repetitive alarm that provides notification of an abnormality is output from a plurality of network facilities for one cause, the maintenance person of the network facilities can quickly specify the cause of the repetitive alarm.

In the network facility monitoring device, in the case of determining that the similarity between the information of the extracted repetitive alarm and the information of the repetitive alarm of the past case is higher than a predetermined threshold, the alarm pattern collation unit 16 instructs the alarm harvesting unit 12 to stop each of the processing of harvesting the repetitive alarm determined to have high similarity and the transmission processing.

With the configuration, it is possible to prevent the predetermined notification destination (host device 30) from suffering a situation in which confirmation work is increased by mass alarm notification and it takes time to repeatedly specify the cause of the repetitive alarm. In addition, it is possible to prevent the alarm harvesting unit 12 from causing alarm delay, alarm omission, or the like due to an increase in the load of the alarm harvesting processing.

In the network facility monitoring device, in the case of being unable to extract the repetitive alarm from the alarm database 11 within a predetermined period after the harvesting of the repetitive alarm is in a stopped state, the repetitive alarm extraction unit 14 instructs the alarm harvesting unit 12 to cancel the stopped state of the harvesting of the repetitive alarm.

With the configuration, in the network facility monitoring device, when detecting that the network facility that has output the repetitive alarm has been restored, the repetitive alarm extraction unit 14 can quickly collate the next repetitive alarm with the repetitive alarm of the past case.

The network facility monitoring method is the network facility monitoring method of the network facility monitoring device 10, the network facility monitoring device 10 includes the alarm database 11 configured to accumulate, as the alarm information, the abnormality detection alarm for providing notification of occurrence of an abnormality and the recovery detection alarm for providing notification of recovery of the abnormality output from the network facility 20 of the optical transmission system 1, and the occurrence recovery alarm pattern database 15 configured to accumulate the information of the repetitive alarm of the past case together with the cause of the repetitive alarm, the network facility monitoring method executing: a step of periodically harvesting the alarm information accumulated in the alarm database 11 and transmitting the alarm information to the predetermined notification destination 30; a step of extracting, as the repetitive alarm, from the alarm database 11, the alarm group in which the abnormality detection alarm and the recovery detection alarm have repeatedly occurred a predetermined number of times within a predetermined time for the same alarm content of the same network facility; and a step of collating the information of the extracted repetitive alarm with the information of the repetitive alarm of the past case, and notifying the predetermined notification destination (host device 30) of the cause of the repetitive alarm of the past case in the case of determining that similarity is higher than a predetermined threshold.

With the configuration, in the network facility monitoring method, the network facility monitoring device 10 can provide notification of the cause of the repetitive alarm of the past case in the case where the past cases having similarity higher than the predetermined threshold are accumulated with respect to the repetitive alarms that provide notification of the occurrence of the abnormality and the recovery of the abnormality. Therefore, the maintenance person of the network facility can quickly specify the cause of the repetitive alarm.

Note that the present invention is not limited to the above-described embodiment, and many modifications can be made by those skilled in the art within the technical idea of the present invention.

For example, the alarm pattern collation unit notifies the host device 30 of the cause of the past case of the repetitive alarm, but the embodiment is not limited thereto, and the alarm pattern collation unit may notify the GUI unit 13. In addition, the alarm pattern collation unit may notify the Host device 30 and the GUI unit 13 of the cause of the past case of the repetitive alarm. Further, the alarm pattern collation unit may notify only the host device 30 of the cause or only the GUI unit 13 of the cause according to the cause of the past case of the repetitive alarm.

In the above-described embodiment, as the feature information of the repetitive pattern, an average value of alarm occurrence intervals, a standard deviation of alarm occurrence intervals, and a ratio of an abnormality duration time in the repetitive alarm have been exemplified, but the embodiment is not limited thereto. The feature information may be statistical information that can be calculated using the time information of the repetitive alarm. This network facility monitoring method can easily add the statistical information obtained by another utilizable calculation method.

In addition, the alarm pattern collation unit determines that the similarity to the repetitive alarm in question is high in the case where the similarity is high in all the three viewpoints regarding the feature information, but the embodiment is not limited thereto. The number of viewpoints regarding the feature information necessary for determining the similarity is determined in advance.

The alarm content is not limited to LOS, and may be another failure state such as loss of frame (LOF).

### REFERENCE SIGNS LIST

1 Optical transmission system
2 Maintenance person
10 Network facility monitoring device
11 Alarm database
12 Alarm harvesting unit
13 GUI unit (notification destination)
14 Repetitive alarm extraction unit
15 Occurrence recovery alarm pattern database
16 Alarm pattern collation unit
20 Network facility
21 Transponder
22 Wavelength selective switch
23 Optical amplifier
30 Host device (notification destination)

1. A network facility monitoring device comprising:
an alarm database configured to accumulate, as alarm information, an abnormality detection alarm for providing notification of occurrence of an abnormality and a recovery detection alarm for providing notification of recovery of the abnormality output from a network facility of an optical transmission system;
an alarm harvesting unit, implemented using one or more processors, configured to periodically harvest the alarm information accumulated in the alarm database and transmit the alarm information to a predetermined notification destination;
a repetitive alarm extraction unit, implemented using one or more processors, configured to extract, as a repetitive alarm, from the alarm database, an alarm group in which the abnormality detection alarm and the recovery detection alarm have repeatedly occurred a predetermined number of times within a predetermined time for same alarm content of the same network facility;
an occurrence recovery alarm pattern database configured to accumulate information of a repetitive alarm of a past case together with a cause of the repetitive alarm; and
an alarm pattern collation unit, implemented using one or more processors, configured to collate information of the extracted repetitive alarm with the information of the repetitive alarm of the past case, and notify the predetermined notification destination of the cause of the repetitive alarm of the past case in a case of determining that similarity is higher than a predetermined threshold.

2. The network facility monitoring device according to claim 1, wherein the information of the repetitive alarm of the past case includes basic information including alarm content information, identification information of a network facility where an alarm has occurred, and information for specifying a location where the alarm has occurred, each of the pieces of information being recorded in association with time information of the abnormality detection alarm or the recovery detection alarm, and statistical information calculated using the time information as feature information of a repetitive pattern, and
the alarm pattern collation unit is configured to calculate statistical information as feature information of a repetitive pattern, using time information of the extracted repetitive alarm, and determine similarity by collating the calculated statistical information with the statistical information of the repetitive alarm of the past case.

3. The network facility monitoring device according to claim 2, wherein the information of the repetitive alarm of the past case includes information indicating whether the repetitive alarm of the past case has spread from the network facility in which the repetitive alarm has occurred to another network facility, and identification information of the another network facility to which the repetitive alarm has spread, and feature information of a repetitive pattern of the repetitive alarm that has occurred as a spread event, and
the alarm pattern collation unit is configured to stand by for a predetermined period in a case where information indicating that the repetitive alarm of the past case in which similarity to the extracted repetitive alarm is determined to be higher than a predetermined threshold has spread is accumulated, and collate information of a new repetitive alarm with the information of the repetitive alarm accumulated as the spread event of the past case to determine similarity in a case where the new repetitive alarm has occurred in the predetermined period.

4. The network facility monitoring device according to claim 1, wherein, in the case of determining that the similarity between the information of the extracted repetitive alarm and the information of the repetitive alarm of the past case is higher than a predetermined threshold, the alarm pattern collation unit is configured to instruct the alarm harvesting unit to stop each of processing of harvesting the repetitive alarm determined to have high similarity and transmission processing.

5. The network facility monitoring device according to claim 4, wherein, in a case of being unable to extract the repetitive alarm from the alarm database within a predetermined period after the harvesting of the repetitive alarm is in a stopped state, the repetitive alarm extraction unit is configured to instruct the alarm harvesting unit to cancel the stopped state of the harvesting of the repetitive alarm.

6. A network facility monitoring method performed by a network facility monitoring device, wherein the network facility monitoring device includes an alarm database configured to accumulate, as alarm information, an abnormality detection alarm for providing notification of occurrence of an abnormality and a recovery detection alarm for providing notification of recovery of the abnormality output from a network facility of an optical transmission system, and an occurrence recovery alarm pattern database configured to accumulate information of a repetitive alarm of a past case together with a cause of the repetitive alarm, and
the network facility monitoring method comprising:
periodically harvesting the alarm information accumulated in the alarm database and transmitting the alarm information to a predetermined notification destination;
extracting, as a repetitive alarm, from the alarm database, an alarm group in which the abnormality detection alarm and the recovery detection alarm have repeatedly occurred a predetermined number of times within a predetermined time for same alarm content of the same network facility; and
collating information of the extracted repetitive alarm with the information of the repetitive alarm of the past case, and notifying the predetermined notification destination of the cause of the repetitive alarm of the past case in a case of determining that similarity is higher than a predetermined threshold.

7. A non-transitory computer readable medium storing a program, wherein execution of the program causes a computer to perform operations comprising:
periodically harvesting the alarm information accumulated in the alarm database and transmitting the alarm information to a predetermined notification destination;
extracting, as a repetitive alarm, from the alarm database, an alarm group in which the abnormality detection alarm and the recovery detection alarm have repeatedly occurred a predetermined number of times within a predetermined time for same alarm content of the same network facility; and
collating information of the extracted repetitive alarm with the information of the repetitive alarm of the past case, and notifying the predetermined notification destination of the cause of the repetitive alarm of the past case in a case of determining that similarity is higher than a predetermined threshold.
